(19) United States
(12) Patent Application Publication
(10) Pub. No.: US 2011/0052983 A1
(43) Pub. Date: Mar. 3, 2011

(54) NEGATIVE ELECTRODE FOR ALKALINE STORAGE BATTERY AND ALKALINE STORAGE BATTERY

(75) Inventors: Yoshifumi Magari, Kobe-shi (JP); Tadayoshi Tanaka, Takatsuki-shi (JP); Shigekazu Yasuoka, Takasaki-shi (JP)

(73) Assignee: SANYO ELECTRIC CO., LTD., Osaka (JP)

(21) Appl. No.: 12/872,601

(22) Filed: Aug. 31, 2010

(30) Foreign Application Priority Data
Aug. 31, 2009 (JP) 2009-199658

(51) Int. Cl. H01M 4/62; H01M 4/525

(52) U.S. Cl. 429/212; 429/209; 429/220; 429/221; 429/223

(57) ABSTRACT

An alkaline storage battery having a positive electrode (1), a negative electrode (2), and an alkaline electrolyte solution, and the negative electrode having fluorinated oil being present on the surface thereof. The negative electrode includes a hydrogen-absorbing alloy represented by the general formula Ln₁₋ₓMgₓNi_{y-a-b}AlₐM_{b}, where Ln is at least one element selected from Zr, Ti, and a rare-earth element including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9.

### BACKGROUND OF THE INVENTION

1. Field of the Invention

The present invention relates to a negative electrode for an alkaline storage battery, a method of manufacturing the negative electrode for an alkaline storage battery, and an alkaline storage battery. More particularly, the invention relates to improvements in a negative electrode for an alkaline storage battery so as to prevent an increase in battery internal pressure during charge without reducing handleability of the negative electrode and to achieve an alkaline storage battery with excellent charge-discharge cycle life.

2. Description of Related Art

Conventionally, nickel-cadmium storage batteries and nickel-metal hydride storage batteries are widely used as alkaline storage batteries.

The nickel-metal hydride storage batteries generally use hydrogen-absorbing alloys for the negative electrodes. Common examples of the hydrogen-absorbing alloys include a LaNi₅-based hydrogen-absorbing alloy that is a rare earth-Ni intermetallic compound having a CaCu₅ type crystal structure as its main phase, a hydrogen-absorbing alloy containing Ti, Zr, V, and Ni and having a Laves phase as its main phase, and a Mg—Ni-rare earth hydrogen absorbing alloy having a crystal structure other than the CaCu₅ type crystal structure, such as a Ce₂Ni₇ type or a CeNi₃ type crystal structure, obtained by allowing the rare earth-Ni hydrogen absorbing alloy to contain Mg and the like.

These types of alkaline storage batteries have the following problems. The negative electrode active material, the positive electrode active material, the alkaline electrolyte solution, and the like need to be filled in a battery can with a limited volume in as large amounts as possible, so the battery internal pressure easily becomes high during charge because of the gas produced when charging the alkaline storage batteries.

When an alkaline storage battery with a higher capacity is desired, it is necessary to fill the electrode active materials in the battery can in even larger amounts, which means that the amount of the electrolyte solution cannot be large. When the amount of the electrolyte solution is insufficient, the amount of the alkaline electrolyte solution contained in the separator decreases as the battery is charged and discharged repeatedly because the electrolyte solution is absorbed in the negative electrode. As a consequence, the internal resistance increases, and the cycle life considerably deteriorates.

This problem is particularly acute when the negative electrode uses a hydrogen-absorbing alloy having high hydrogen-absorbing capability.

In view of the problem, it has been proposed to coat the surface of a negative electrode comprising a hydrogen-absorbing alloy with a fluororesin to provide the negative electrode surface with water repellency, whereby the oxygen gas produced is decreased and the battery internal pressure is lowered efficiently, as shown in Japanese Published Unexamined Patent Application No. 61-118963.

However, the above-described alkaline storage battery in which the negative electrode surface is coated with a fluororesin has the following problems. When the amount of the coating is small, sufficient water repellency cannot be obtained and the battery internal pressure cannot be lowered sufficiently. In addition, when the negative electrode surface is coated with a fluororesin, the resulting electrode plates tend to adhere to each other, reducing handleability of the electrode plates in mass production. Moreover, it is necessary to coat a certain amount of fluororesin in order to obtain the effects of providing the negative electrode surface with water repellency and reducing the battery internal pressure. In such a case, the electrode plate handleability becomes particularly poor.

### BRIEF SUMMARY OF THE INVENTION

Accordingly, it is an object of the present invention to solve the foregoing and other problems in alkaline storage batteries. In particular, it is an object of the invention to prevent an increase in battery internal pressure during charge without reducing the handleability of the negative electrode in an alkaline storage battery that employs a negative electrode using a hydrogen-absorbing alloy, especially a Mg—Ni-rare earth hydrogen absorbing alloy, and also to provide an alkaline storage battery having excellent cycle life.

In order to accomplish the foregoing and other objects, the present invention provides an alkaline storage battery, comprising fluorinated oil being present on a negative electrode surface.

The fluorinated oil may be at least one selected from perfluoropolyether and a low polymer of chlorotrifluoroethylene. A low polymer of chlorotrifluoroethylene includes polymers having a low molecular mass which would preserve a liquid state at the range of 25° C.-70° C. The low polymer of chlorotrifluoroethylene may also have a number average molecular mass of from 500 to 1300.

Although the type of the negative electrode used is not particularly limited, it is preferable to use a hydrogen-absorbing alloy, especially a hydrogen-absorbing alloy having a crystal structure other than a CaCu₅ type, such as a Ce₂Ni₇ type or a CeNi₃ type crystal structure, which has excellent hydrogen-absorbing capability. An example is a hydrogen-absorbing alloy represented by the general formula Ln₁₋ₓMgₓNi_{y-a-b}AlₐM_{b}, where Ln is at least one element selected from Zr, Ti, and a rare-earth element including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9.

The alkaline storage battery according to the present invention comprises a positive electrode, a negative electrode, and an alkaline electrolyte solution, and employs the above-described negative electrode for an alkaline storage battery as its negative electrode.

In the present invention, the negative electrode for an alkaline storage battery has fluorinated oil being present on the negative electrode surface. This enables the negative electrode surface to have water repellency without reducing handleability of the electrode plate.

Handleability of the electrode plate does not reduce when fluorinated oil is present on the negative electrode surface. This is because fluorinated oil, which has high fluidity, exists in the irregular microstructure of the surface of the negative electrode active material in the negative electrode surface. If handleability of the electrode plate does not reduce, productivity and quality of the products do not become poor in mass production, which is very useful.

Moreover, the present invention makes it possible to reduce the oxygen gas produced during charge because of the water repellency of the negative electrode surface. As a result, the battery internal pressure is reduced efficiently.

In the present invention, the water repellency of the negative electrode surface serves to decrease the contact area between the negative electrode surface and the electrolyte solution. Therefore, it is possible to lessen the electrolyte solution that is absorbed in the negative electrode even when the battery is charged and discharged repeatedly. As a result, the amount of the alkaline electrolyte solution contained in the separator is inhibited from decreasing, and the internal resistance of the alkaline storage battery is prevented from increasing. Thus, the cycle life of the alkaline storage battery is improved.

Since the fluorinated oil has high water repellency and shows fluidity, the fluorinated oil easily fits on the negative electrode surface and exists in a wide spread condition when coated on the negative electrode surface. For this reason, even with a small amount of the fluorinated oil, it is possible to provide sufficient water repellency for the negative electrode surface. Nevertheless, if the amount of the fluorinated oil in the negative electrode surface is less than 0.01 mg/cm² with respect to the negative electrode, sufficient water repellency cannot be obtained. If the amount of the fluorinated oil in the negative electrode surface is greater than 0.3 mg/cm², the water repellency of the negative electrode surface will be too high, reducing the contact area between the negative electrode surface and the electrolyte, and consequently, the discharge characteristics will become poor.

In addition, when a hydrogen-absorbing alloy, particularly a hydrogen-absorbing alloy represented by the foregoing general formula Ln₁₋ₓMgₓNi_{y-a-b}AlₐM_{b}, is used as the negative electrode material in the present invention, the advantageous effects of the present invention of lowering the battery internal pressure during charge and significantly improving the cycle life are evident. The reason is that water repellency in the negative electrode surface is preserved easily because the hydrogen-absorbing alloy does not easily pulverize even when charged and discharged repeatedly.

In fabricating the negative electrode for an alkaline storage battery of the present invention, it is unnecessary to prepare a dispersion of fluorinated oil using water or an organic solvent when coating the fluorinated oil onto the negative electrode surface, and the fluorinated oil alone may be coated onto the negative electrode surface using a brush or the like. This means that, after coating the fluorinated oil onto the negative electrode surface, it is possible to obtain the negative electrode for an alkaline storage battery in which the fluorinated oil is present on the negative electrode surface without necessitating a drying process by a heat treatment. Accordingly, a drying process and an exhaust apparatus for organic solvents are unnecessary in fabricating the negative electrode for an alkaline storage battery according to the present invention. This is advantageous in terms of production efficiency and costs.

### BRIEF DESCRIPTION OF THE DRAWINGS

FIG. 1 is a schematic cross-sectional view illustrating an alkaline storage battery prepared for Example 1 of the present invention and Comparative Examples 1 through 3.

### DETAILED DESCRIPTION OF THE INVENTION

Hereinbelow, examples of the negative electrode for an alkaline storage battery, the method of manufacturing the negative electrode, and the alkaline storage battery employing the negative electrode for an alkaline storage battery according to the present invention will be described in detail. In addition, it will be demonstrated that the examples of the alkaline storage battery employing the negative electrode for an alkaline storage battery according to the invention make it possible to prevent an increase in the internal pressure during charge without reducing handleability of the negative electrode, and to obtain an alkaline storage battery with excellent charge-discharge cycle life. It should be noted that the negative electrode for an alkaline storage battery and the alkaline storage battery according to the invention are not limited to those illustrated in the following examples, and various changes and modifications are possible within the scope of the invention.

### Example 1

In Example 1, a negative electrode and a positive electrode that were prepared in the following manner were used to prepare an alkaline storage battery.

### Preparation of Negative Electrode

The negative electrode was prepared in the following manner. Nd, Sm, Mg, Ni, and Al were mixed at a predetermined alloy composition, and the mixture was melted with a high frequency induction furnace. Thereafter, the resultant material was cooled, whereby a hydrogen-absorbing alloy ingot was obtained.

Then, the ingot was heat-treated to make it uniform in quality, and thereafter pulverized in an inert atmosphere. The pulverized material was classified to obtain hydrogen-absorbing alloy powder having an average particle size of 65 μm at a mass integral of 50%. The composition of the resultant hydrogen-absorbing alloy was analyzed by inductively-coupled plasma spectrometry (ICP). As a result, the composition was found to be Nd_{0.36}Sm_{0.54}Mg_{0.10}Ni_{3.33}Al_{0.17.}

Then, 1 part by mass of styrene-butadiene copolymer rubber (SBR), 0.2 parts by mass of sodium polyacrylate, 0.2 parts by mass of carboxymethylcellulose, 1 part by mass of Ketjen Black, and 50 parts by mass of water were added to 100 parts by mass of the above-described hydrogen-absorbing alloy powder, and these were kneaded at room temperature, to prepare a paste.

Next, the resulting paste was applied uniformly onto both sides of a conductive current collector made of punched metal, and then dried. The resultant material was then pressed and thereafter cut into predetermined dimensions, to prepare a negative electrode.

Thereafter, a low polymer of chlorotrifluoroethylene, which is a fluorinated oil, was coated on the negative electrode surface with the use of a brush. Thus, a negative electrode of Example 1 was prepared. The amount of the fluorinated oil coated was 0.1 mg/cm².

### Preparation of Positive Electrode

A positive electrode was prepared in the following manner. Nickel hydroxide powder containing 2.5 mass % of zinc and 1.0 mass % of cobalt was put into an aqueous cobalt sulfate solution, and 1 mole of aqueous sodium hydroxide solution was gradually dropped into the mixture while stirring to cause them to react with each other until the pH became 11. Thereafter, the resulting precipitate was filtered, washed with water, and vacuum dried. Thus, nickel hydroxide the surface of which was coated with 5 weight % of cobalt hydroxide was obtained.

Next, a 25 mass % of aqueous sodium hydroxide solution was added and impregnated to the nickel hydroxide the surface of which was coated with cobalt hydroxide, at a weight ratio of 1:10. The resultant material was heated at 85° C. for 8 hours while stirring. Thereafter, this was washed with water and dried at 65° C. Thereby, a positive electrode material in which the surface of the nickel hydroxide was coated with a sodium-containing higher valence cobalt oxide was obtained.

Subsequently, 95 parts by mass of the positive electrode material thus prepared, 3 parts by mass of zinc oxide, and 2 parts by weight of cobalt hydroxide were mixed together, and to the mixture, 50 parts by weight of an aqueous solution of 0.2 mass % hydroxypropylcellulose, serving as a binder agent, was added and mixed together, to prepare a slurry.

The resulting slurry was then filled into a nickel foam having a basis weight of about 600 g/m², a porosity of 95%, and a thickness of about 2 mm, and then dried. The resultant material was calendered while controlling the positive electrode active material density to be about 2.9 g/cm³-void. Thereafter, the resultant material was cut into predetermined dimensions, to prepare a positive electrode comprising a non-sintered nickel electrode.

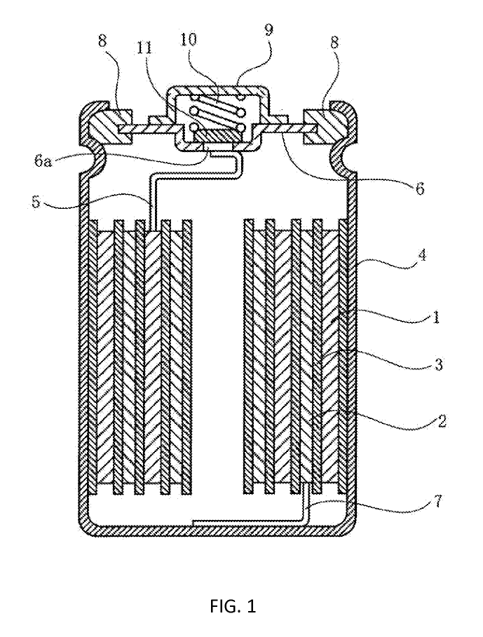

A separator used was a polypropylene non-woven fabric having sulfonic groups that was obtained by subjecting a polypropylene non-woven fabric to a fluorination process using a fluorinated gas and sulfur dioxide gas. An alkaline electrolyte solution used was an alkaline electrolyte solution containing KOH, NaOH, and LiOH at a mass ratio of 15:2:1 and having a specific gravity of 1.30. Using these components, an AA-size cylindrical alkaline storage battery as illustrated in FIG. 1 was fabricated, which had a design capacity of 1500 mAh.

The just-described alkaline storage battery was assembled in the following manner, as illustrated in FIG. 1. The positive electrode 1 and the negative electrode 2, prepared in the above-described manner, were spirally coiled with the separators 3 interposed therebetween, and these were accommodated in a battery can 4. The positive electrode 1 was connected to a positive electrode cap 6 by a positive electrode lead 5, and the negative electrode 2 was connected to the battery can 4 by a negative electrode lead 7. Then, the alkaline electrolyte solution was poured into the battery can 4. Thereafter, an insulative packing 8 was placed between the battery can 4 and the positive electrode cap 6, and the battery can 4 was sealed. The battery can 4 and the positive electrode cap 6 were electrically insulated by the insulative packing 8. A closing plate 11 urged by a coil spring 10 was provided between the positive electrode cap 6 and a positive electrode external terminal 9. When the internal pressure of the battery unusually increases, the coil spring 10 can be compressed to release gas from the interior of the battery to the atmosphere.

### Comparative Example 1

In Comparative Example 1, a negative electrode and an alkaline storage battery of Comparative Example 1 were fabricated in the same manner as described in Example 1 above, except that the low polymer of chlorotrifluoroethylene, which is a fluorinated oil, was not coated when preparing the negative electrode in the manner as described in Example 1 above.

### Comparative Example 2

In Comparative Example 2, a negative electrode and an alkaline storage battery of Comparative Example 2 were fabricated in the same manner as described in Example 1 above, except that a water dispersion of polytetrafluoroethylene, which is a fluororesin, was coated on the negative electrode, in place of the low polymer of chlorotrifluoroethylene, which is a fluorinated oil, and dried at 80° C. for 20 minutes, when preparing the negative electrode in the manner as described in Example 1 above. The amount of the polytetrafluoroethylene coated was 0.1 mg/cm².

### Comparative Example 3

In Comparative Example 3, a negative electrode and an alkaline storage battery of Comparative Example 3 were fabricated in the same manner as described in Example 1 above, except that a water dispersion of polytetrafluoroethylene, which is a fluororesin, was coated on the negative electrode, in place of the low polymer of chlorotrifluoroethylene, which is a fluorinated oil, and dried at 80° C. for 20 minutes, when preparing the negative electrode in the manner as described in Example 1 above. The amount of the polytetrafluoroethylene coated was 0.3 mg/cm².

Then, the alkaline storage batteries of Example 1 and Comparative Examples 1 to 3, prepared in the above-described manners, were charged at a current of 150 mAh for 16 hours and thereafter discharged at a current of 1500 mA until the battery voltage reached 1.0 V. This charge-discharge cycle was repeated three times to activate the alkaline storage batteries.

A hole was formed in the bottom of the battery can of each of the alkaline storage batteries of Example 1 and Comparative Examples 1 to 3, and a pressure sensor was connected thereto. Thereafter, each of the batteries was charged at a current of 1500 mA until the battery voltage reached the maximum value and thereafter dropped by 10 mV, and the maximum battery internal pressure in this process was obtained. Taking the battery internal pressure of the alkaline storage battery of Comparative Example 1 as 100, the internal pressure ratio of each of the alkaline storage batteries was obtained. The results are shown in Table 1 below.

In addition, the alkaline storage batteries of Example 1 and Comparative Examples 1 to 3, which were activated in the just-described manner, were charged at a current of 1500 mA, and after the battery voltage reached the maximum value, the batteries were further charged until the battery voltage lowered by 10 mV. Then, the batteries were set aside for 30 minutes. Thereafter, the batteries were discharged at a current of 1500 mA until the battery voltage reached 1.0 V, and they were set aside for 30 minutes. This charge-discharge cycle was repeated to obtain the number of the cycles of each of the alkaline storage batteries at which the discharge capacity of each battery reached 1000 mAh, and taking the number of the cycles of Comparative Example as 100, the cycle life ratio of each of the alkaline storage batteries was obtained. The results are also shown in Table 1 below.

In addition, using the negative electrodes of Example 1 and Comparative Examples 1 to 3, five electrode plates of each sample were stacked together, and a 1-kg weight was placed on each set of the electrode plates. The samples were set aside for 1 day. Then, adhesion of the electrode plates was confirmed to determine the electrode plate handleability. It was determined that the electrode plate handleability was good if, when an electrode plate was lifted, another electrode plate did not adhere thereto (i.e., the electrode plates did not adhere to each other). It was determined that the electrode plate handleability was fair if, when an electrode plate was lifted, another electrode plate adhered thereto but peeled off because of the weight of the electrode plate (i.e., the electrode plates slightly adhered to each other). It was determined that the electrode plate handleability was poor if, when an electrode plate was lifted, another electrode plate adhered thereto and needed to be peeled off by hand (i.e., the electrode plates completely adhered to each other). The results are also shown in Table 1 below.

TABLE 1

| | | | Battery | | |
|---|---|---|---|---|---|
| | | Coating | internal | | Electrode |
| | Substance coated on | amount | pressure | Cycle | plate |
| | negative electrode surface | (mg/cm²) | ratio | life | handleability |
| Example 1 | Low polymer of | 0.1 | 90 | 110 | Good |
| | chlorotrifluoroethylene | | | | |
| Comparative | — | — | 100 | 100 | Good |
| Example 1 | | | | | |
| Comparative | polytetrafluoroethylene | 0.1 | 95 | 104 | Fair |
| Example 2 | | | | | |
| Comparative | polytetrafluoroethylene | 0.3 | 90 | 110 | Poor |
| Example 3 | | | | | |

The results demonstrate that the alkaline storage battery of Example 1, having 0.1 mg/cm² of a low polymer of chlorotrifluoroethylene, which is a fluorinated oil, being present on the negative electrode surface, was superior in battery internal pressure characteristic and cycle life to the alkaline storage battery of Comparative Example 1, in which no fluorinated oil was present on the negative electrode surface. In addition, the alkaline storage battery of Example 1 was superior in battery internal pressure characteristic and cycle life to the alkaline storage battery of Comparative Example 2, having 0.1 mg/cm2 of polytetrafluoroethylene, which is a fluororesin, being present on the negative electrode surface. Furthermore, the negative electrode of Example 1 exhibited better electrode plate handleability than the negative electrode of Comparative Example 2.

Although the alkaline storage battery of Comparative Example 3, having 0.3 mg/cm² of polytetrafluoroethylene, which is a fluororesin, on the negative electrode surface, showed a battery internal pressure characteristic and a cycle life comparable to those of the alkaline storage battery of Example 1, the negative electrode of Comparative Example 3 showed considerably poorer electrode plate handleability than the negative electrode of Example 1. The reason is believed to be as follows.

When the negative electrode surface is coated with fluorinated oil, the electrode plates do not adhere to each other even if the electrode plates are stacked together, because fluorinated oil, which has high fluidity, is present in the irregular microstructure of the negative electrode active material surface in the negative electrode surface. On the other hand, when the negative electrode surface is coated with a fluororesin, particles of the fluororesin exist scatteredly on the irregular microstructure of the negative electrode active material surface in the negative electrode surface because the fluororesin has a lower fluidity and a lower dispersion capability. Consequently, particles the fluororesin tend to adhere to each other easily when the electrode plates are stacked together. When the amount of the fluororesin coated is increased, the electrode plate handleability becomes worse.

The above results demonstrate that a negative electrode for an alkaline storage battery and an alkaline storage battery that are superior in all of the battery internal pressure characteristic, the cycle life, and the electrode plate handleability can be obtained by allowing fluorinated oil to be present on the negative electrode surface.

It should be noted that although the above example and comparative examples use a low polymer of chlorotrifluoroethylene as the fluorinated oil, the same advantageous effects can be obtained when perfluoropolyether is used as the fluorinated oil.

Although the above example uses the hydrogen-absorbing alloy represented by the foregoing general formula Ln₁₋ₓMgₓNi_{y-a-b}AlₐM_{b} as the negative electrode material, the same advantageous effects resulting from the fluorinated oil can be obtained when using other negative electrode materials, such as other hydrogen-absorbing alloys and cadmium.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A negative electrode for an alkaline storage battery, comprising fluorinated oil being present on a negative electrode surface.

2. The negative electrode for an alkaline storage battery according to claim 1, wherein the fluorinated oil is at least one of perfluoropolyether and a low polymer of chlorotrifluoroethylene.

3. The negative electrode for an alkaline storage battery according to claim 1, further comprising a hydrogen-absorbing alloy as a negative electrode active material.

4. The negative electrode for an alkaline storage battery according to claim 2, further comprising a hydrogen-absorbing alloy as a negative electrode active material.

5. The negative electrode for an alkaline storage battery according to claim 3, wherein the hydrogen-absorbing alloy is represented by the general formula Ln₁₋ₓMgₓNi_{y-a-b}AlₐM_{b}, where Ln is at least one element selected from Zr, Ti, and a rare-earth element including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9.

6. The negative electrode for an alkaline storage battery according to claim 4, wherein the hydrogen-absorbing alloy is represented by the general formula Ln₁₋ₓMgₓNi_{y-a-b}AlₐM_{b}, where Ln is at least one element selected from Zr, Ti, and a rare-earth element including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9.

7. The negative electrode for an alkaline storage battery according to claim 1, wherein the fluorinated oil is a perfluoropolyether.

8. The negative electrode for an alkaline storage battery according to claim 1, wherein the fluorinated oil is a low polymer of chlorotrifluoroethylene.

9. The negative electrode for an alkaline storage battery according to claim 8, wherein the low polymer of chlorotrifluoroethylene has a molecular mass which would preserve a liquid state in the range of from 25° C. to 70° C.

10. The negative electrode for an alkaline storage battery according to claim 9, wherein the low polymer of chlorotrifluoroethylene has a number average molecular mass of from 500 to 1300.

11. An alkaline storage battery comprising a positive electrode, a negative electrode, and an alkaline electrolyte solution, the negative electrode being a negative electrode for an alkaline storage battery according to claim 1.

12. An alkaline storage battery comprising a positive electrode, a negative electrode, and an alkaline electrolyte solution, the negative electrode being a negative electrode for an alkaline storage battery according to claim 2.

13. An alkaline storage battery comprising a positive electrode, a negative electrode, and an alkaline electrolyte solution, the negative electrode being a negative electrode for an alkaline storage battery according to claim 3.

14. An alkaline storage battery comprising a positive electrode, a negative electrode, and an alkaline electrolyte solution, the negative electrode being a negative electrode for an alkaline storage battery according to claim 4.

15. An alkaline storage battery comprising a positive electrode, a negative electrode, and an alkaline electrolyte solution, the negative electrode being a negative electrode for an alkaline storage battery according to claim 5.

16. An alkaline storage battery comprising a positive electrode, a negative electrode, and an alkaline electrolyte solution, the negative electrode being a negative electrode for an alkaline storage battery according to claim 6.
